(19) United States
(12) Patent Application Publication
(10) Pub. No.: US 2016/0146924 A1
(43) Pub. Date: May 26, 2016

(54) INTRINSIC SAFETY BARRIER CIRCUIT WITH SERIES BLOCKING CAPACITOR

(71) Applicant: HONEYWELL INTERNATIONAL INC., MORRISTOWN, NJ (US)

(72) Inventor: MICHAEL WILLIAMS, COQUITLAM (CA)

(21) Appl. No.: 14/608,791

(22) Filed: Jan. 29, 2015

Related U.S. Application Data
(60) Provisional application No. 62/085,112, filed on Nov. 26, 2014.

(51) Int. Cl. G01S 7/02; G01F 23/284

(52) U.S. Cl. CPC G01S 7/02; G01F 23/284

(57) ABSTRACT

A radar system for level sensing a product in a tank includes a radar level gauge (RLG) including a transceiver that provides a RF output coupled to a coaxial connector that has its center conductor coupled to a probe at a top of the tank or extending into the tank. The RLG includes a processor coupled to a transceiver which has an associated memory that includes a stored level finding algorithm. An intrinsic safety (IS) barrier circuit is formed on a circuit board and includes a signal path that has an input for coupling to RF output. The IS barrier circuit includes at least one blocking capacitor (C1, C2) positioned in the signal path and there is at least one diode (D2, D3 and D4) coupled between the signal path and ground.

### CROSS REFERENCE TO RELATED APPLICATIONS

This application claims the benefit of Provisional Application Ser. No. 62/085,112 entitled “INTRINSIC SAFETY BARRIER CIRCUIT WITH SERIES BLOCKING CAPACITOR”, filed Nov. 26, 2014, which is herein incorporated by reference in its entirety.

### FIELD

Disclosed embodiments relate to radar level gauge systems that use electromagnetic waves for measuring the level of a product in a container, and more specifically to intrinsic safety devices that limit the energy at the probe in the system particularly during fault conditions so that a combustible material in the tank is prevented from igniting during the fault conditions.

### BACKGROUND

Radar level gauges (RLGs) are commonly used for measurements of the level of products such as process fluids, granular materials and other materials. An example of such a radar level gauge includes a transceiver for transmitting and receiving microwaves, a propagation device (e.g., an antenna or a guided wave probe (i.e. transmission line suspended from top to bottom in the tank) arranged to direct microwaves and to couple returned microwaves affected by the product surface to the transceiver, timing circuitry adapted to control the transceiver and to determine the level based on a time relation between microwaves transmitted and received by the transceiver, and an interface arranged to receive power and to connect the radar level gauge externally thereof.

When level measurements are made by a probe in a tank containing a combustible material that is generally a gas or a liquid, or in other situations where the RLG is located in an explosion endangered area, it is required that the RLG system be designed for the hazardous location. This requirement is generally fulfilled using an intrinsically safe (IS) design, in which a barrier device, such as a zener diode, is implemented to limit voltages, current and power at the radio frequency (RF) output that is supplied to the probe which extends into the tank.

FIG. 1A depicts a conventional RLG system 100 where the entire RLG system 100 is IS. In the non-hazardous area there is a source of AC voltage 110, typically providing 250 VAC at 50 or 60 Hz, that is coupled to control equipment (e.g., process controllers) 120 which is coupled to an IS barrier 125. In the hazardous area there is a RLG 130 coupled between the IS barrier 125 and a probe (or waveguide) 240, where the RLG 130 has an RF input/output (shown as RF out) 131 that is coupled to the probe 240.

More generally, RF outputs, including those used in guided wave radar (GWR) applications, need an RF output which is IS for hazardous location applications, including applications which where the RLG 130 is installed in an explosion proof enclosure. FIG. 1B depicts a conventional RLG system 150 where the RLG 130 is installed as explosion proof and the probe 240 is IS. The RLG 130, IS barrier 125 and associated wiring are all shown within an explosion proof enclosure 180 that is within the hazardous area. The probe 240 is thus rendered IS so that it is prevented from igniting a combustible material in the tank 205 even during fault conditions. In this RLG system 150 embodiment the IS barrier 125 generally comprises a zener diode shunt and/or galvanic isolation, which are both generally bulky and expensive IS barrier solutions.

### SUMMARY

This Summary is provided to comply with 37 C.F.R. §1.73, presenting a summary to briefly indicate the nature and substance of this Disclosure. It is submitted with the understanding that it will not be used to interpret or limit the scope or meaning of the claims.

Disclosed embodiments describe intrinsic safety (IS) barrier circuits with series blocking capacitor(s) and clamping diode(s) coupled between the radar gauge and the probe (or waveguide) in a radar level gauge (RLG) system which renders the RF output of the RF input/output of the RLG for transmissions a protected RF output and thus the probe coupled thereto limited in energy. As a result, even during fault conditions, the probe is prevented from igniting a combustible material in the tank due to the limited energy. Disclosed IS barrier circuits remove the need for conventional galvanic isolation or bulky IS barriers. As an added benefit, disclosed IS barriers also provide electrostatic discharge (ESD) protection to the electronics of the RLG.

Disclosed IS barriers essentially also do not add significant high frequency attenuation to the RF output. In contrast, conventional IS barriers add unwanted impedance (and thus attenuation) to the RF signal. Typically, clamping (zener) diodes cannot be added to an RF output since they add unwanted capacitance and too much RF attenuation. It is recognized that the impedance of a capacitor is equal to 1/(2πfc), where c is the capacitance and f is the frequency. Therefore disclosed IS barrier circuits add a relatively large low frequency (AC mains frequency) impedance, which allows the use of an IS barrier having small size, low power, low capacitance ESD diode(s) resulting in an IS RF output with low RF attenuation.

### BRIEF DESCRIPTION OF THE DRAWINGS

FIG. 1A depicts a conventional RLG system where the entire system is IS.

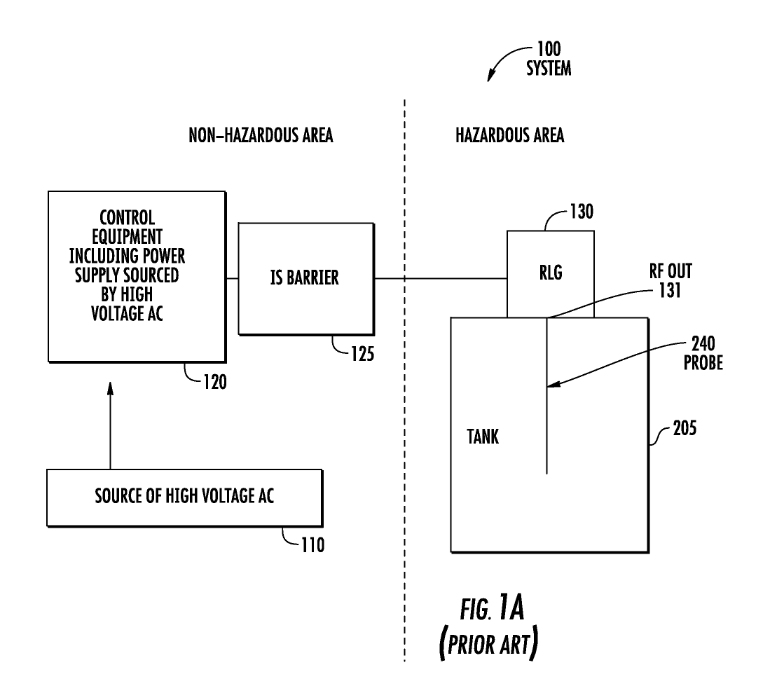

FIG. 1B depicts a conventional RLG system where the radar gauge is installed as explosion proof and the probe is IS.

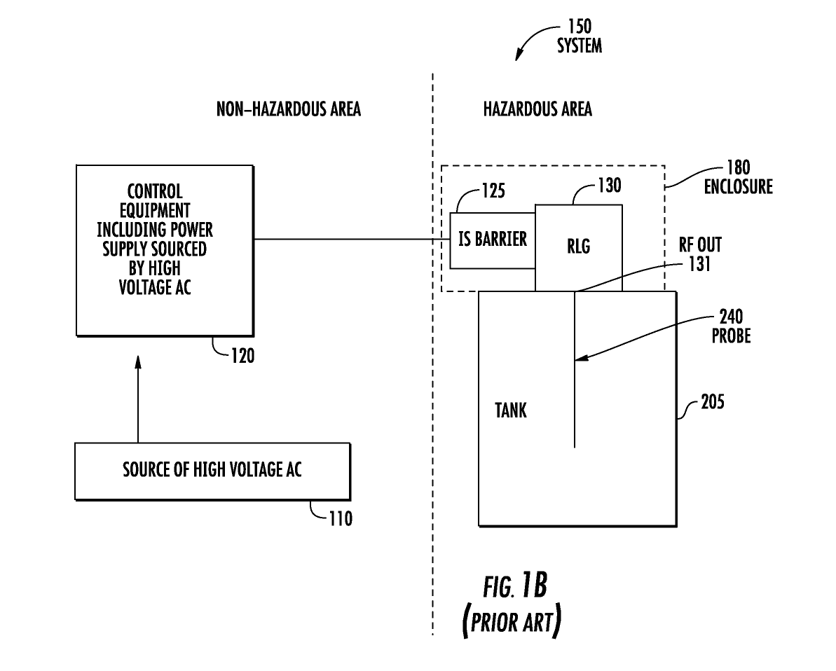

FIG. 2A depicts an example GWR system that a disclosed IS barrier circuit is positioned between the transceiver of a RLG and the probe, according to an example embodiment.

FIG. 2B depicts an example RLG system where the RLG is installed as explosion proof and the probe is IS, where the IS barrier circuit is positioned between the RLG and the probe, according to an example embodiment.

FIG. 3A shows a design of an example IS barrier circuit, according to an example embodiment.

FIG. 3B shows a design of another example IS barrier circuit, according to an example embodiment.

### DETAILED DESCRIPTION

Disclosed embodiments are described with reference to the attached figures, wherein like reference numerals, are used throughout the figures to designate similar or equivalent elements. The figures are not drawn to scale and they are provided merely to illustrate aspects disclosed herein. Several disclosed aspects are described below with reference to example applications for illustration. It should be understood that numerous specific details, relationships, and methods are set forth to provide a full understanding of the embodiments disclosed herein.

One having ordinary skill in the relevant art, however, will readily recognize that the disclosed embodiments can be practiced without one or more of the specific details or with other methods. In other instances, well-known structures or operations are not shown in detail to avoid obscuring aspects disclosed herein. Disclosed embodiments are not limited by the illustrated ordering of acts or events, as some acts may occur in different orders and/or concurrently with other acts or events. Furthermore, not all illustrated acts or events are required to implement a methodology in accordance with this Disclosure.

Also, the terms “coupled to” or “couples with” (and the like) as used herein without further qualification are intended to describe either an indirect or direct electrical connection. Thus, if a first device “couples” to a second device, that connection can be through a direct electrical connection where there are only parasitics in the pathway, or through an indirect electrical connection via intervening items including other devices and connections. For indirect coupling, the intervening item generally does not modify the information of a signal but may adjust its current level, voltage level, and/or power level.

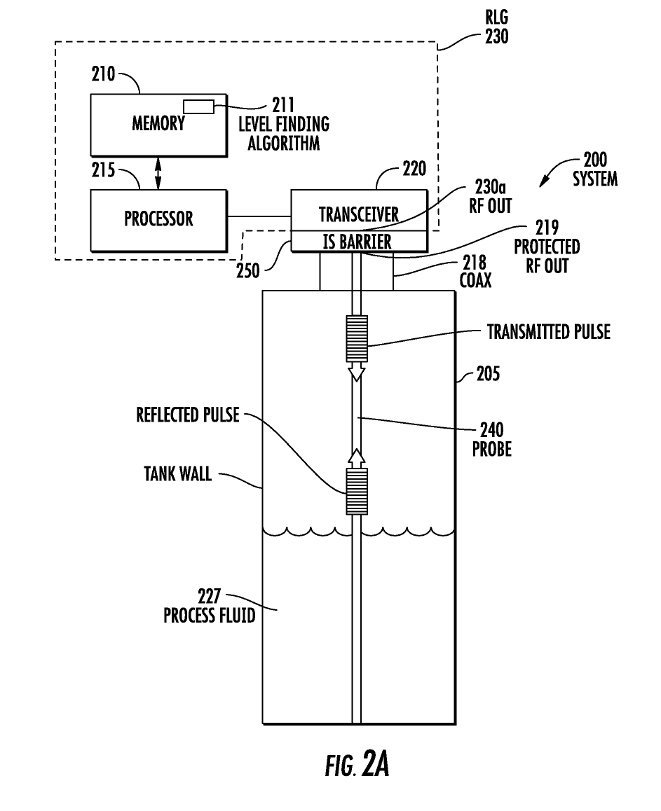

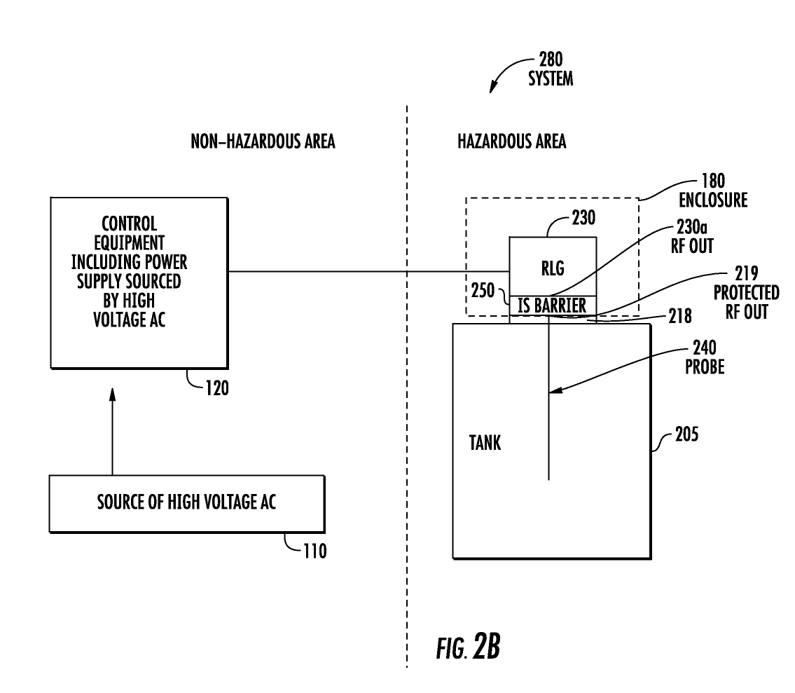

FIG. 2A depicts an example GWR system 200 having a disclosed IS barrier circuit 250 positioned between a transceiver 220 of a RLG 230 and the probe 240, according to an example embodiment. A process fluid 227 is shown in the tank 205 that is itself flammable and/or has a flammable gas above it. GWR system 200 also includes a coaxial connector 218 that is on the top of the tank 205 with its center conductor coupled to the probe (or waveguide) 240 which extends into the tank 205. The RLG 230 also includes a processor 215 which has an associated memory 210, where the transceiver 220 is coupled to the processor 215, and the associated memory 210 includes a stored level finding algorithm 211 (e.g., a Time Domain Reflectometry (TDR) algorithm).

The IS barrier circuit 250 is shown between the coaxial connector 218 and the transceiver 220. The IS barrier circuit 250 receives the RF output 230a from the RF input/output of the RLG 230 and outputs a protected RF output 219. A flange (not shown) may also be present on the top of the tank 205. In operation of the GWR system 200, a transmitted pulse from the transceiver 220 is launched along probe 240 which returns as the reflected pulse shown that is processed by the processor 215. The transmitted pulse may be at about 1.5 GHz. Although generally described for GWR applications, disclosed IS barrier circuits can also be applied to protect the electronics in other systems including the electronics in non-contact radar systems. In all such systems, it is recognized that during fault conditions, including faults from a source of high voltage (e.g., AC mains supply) fed to the device(s) needs to be energy limited to help keep the RF output which enters the hazardous location/area IS.

FIG. 2B depicts an example RLG system 280 where the radar gauge 230 is installed as explosion proof with an enclosure 180 within a hazardous area, and the probe 240 is IS, where the IS barrier circuit 250 is between the RLG 230 and the probe 240, according to an example embodiment. The disclosed IS barrier circuit 250 is small in size, typically being mounted on a small area printed circuit board (PCB) along with the electronics of the RLG 230.

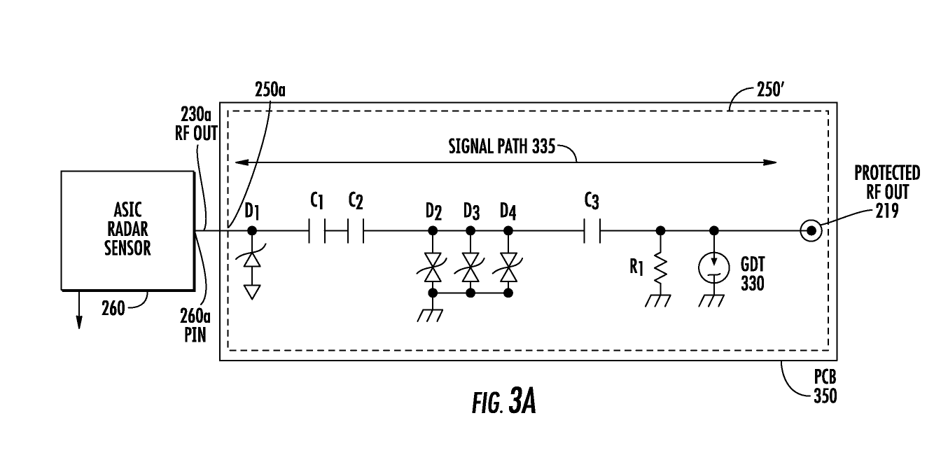

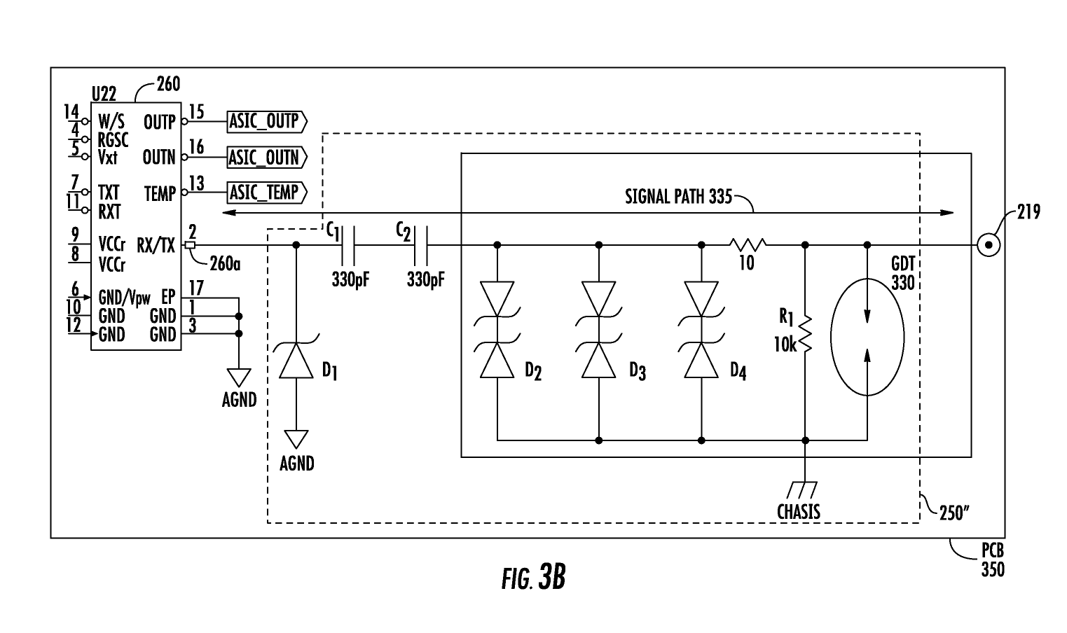

FIG. 3A shows a design for an example IS barrier circuit 250′ including a signal path 335 in series with an RF input/output shown as RF out 230a of radar sensor shown as application-specific integrated circuit (ASIC) radar sensor circuit 260, according to a disclosed embodiment. IS barrier circuit 250′ is shown on PCB 350. IS barrier circuit 250′ includes blocking capacitors shown as C1 and C2, where capacitors generally are conventionally considered IS by providing galvanic isolation to DC current only. However, a single blocking capacitor (C1 or C2) may be used for disclosed IS barrier circuits. Blocking capacitors C1 and C2 are positioned in barrier circuit 250′ within the signal path 335, where an input 250a of the barrier circuit 250′ receives the RF output 230a from pin 260a of ASIC radar sensor circuit 260 and provides a protected RF output 219 (shown as a coaxial output).

Barrier circuit 250′ provides high impedance from the AC mains frequencies provided by the source of AC voltage 110, typically 250 VAC at 50 or 60 Hz, that in FIG. 2B is shown coupled to control equipment (e.g., process controllers) 120 in the non-hazardous area. C1 and C2 function to limit the power to the lower capacitance ESD diodes (typically having a capacitance of 1 pF or less) shown as back-to back zener diode pairs D2, D3, and D4, such that D2, D3, D4 shunt the voltage on the protected RF output 219 to a level well within IS levels before reaching the probe 240 for keeping the energy reaching the probe 240 low enough (even in fault conditions) so that it is not a source of ignition for a combustible in the tank.

Zener diodes can be replaced by other shunting diodes, or signal diodes arranged to limit the voltage. As noted above, C1 and C2 can be replaced by a single capacitor for certain lower levels of IS in accordance with IS standards. D2, D3, D4 can be replaced by 2 diode pairs, 1 diode pair, or as explained below even a single diode depending on the level of IS needed. A chassis ground is shown on the low side of D2, D3, D4, as well as R1 and GDT 330, while an analog ground (AGND) is shown on the low side of D1 and for ASIC radar sensor circuit 260.

It is recognized herein that a single diode for voltage clamping can be used if in normal operating modes the RF signal has a relatively low voltage amplitude. A diode will clamp in the positive polarity (i.e. to reverse bias the diode) only when the voltage of the RF signal exceeds the diode's breakdown voltage. The same diode will also clamp in the negative direction (i.e. to forward bias the diode) when the voltage of the RF signal is negative provided it is higher in amplitude than its forward conducting voltage typically below 1V (e.g., about 0.6 to 0.7 V at room temperature for a silicon pn diode). For example, if the RF signal voltage is normally always greater than −1V, a single diode can thus be used to clamp RF signals for either polarity. Additional diodes such as shown in FIG. 3A (and FIG. 3B described below) can be added to increase the clamping threshold. Similarly, other arrangements of diodes can be made to tailor both the positive and negative clamping amplitudes as desired.

Since the RF frequency used by GWR system 200 or 280 is relatively high, such as about 1.5 GHz, it is recognized that small value capacitors, such as on the order of several hundred pFs can be used for the blocking capacitors shown as C1 and C2 without adding any significant attenuation to the RF signal. Use of small value capacitors result in essentially no power dissipation across D2, D3, D4 during continuous radar operation, and very low power dissipation during fault conditions.

The barrier circuit 250′ can be expanded to include other components, such as by adding the resistor shown as R1 and a gas discharge tube (GDT) 330 shown for static discharge protection of a probe or antenna coupled to the RF output 219, without compromising the IS. Another capacitor C3 is also shown in FIG. 3A added to provide an impedance between the static discharge components R1 and GDT 330 and the low voltage clamping capabilities of D2, D3, and D4. Another diode shown as D1 being a Zener diode can be added to provide further ESD and transient protection to the RF generating device, e.g., the ASIC radar sensor circuit 260, directly between its pin 260a and a local ground reference (not shown).

FIG. 3B shows a design of another example intrinsic safety barrier circuit 250″, according to a disclosed embodiment. The barrier circuit 250″ can be together on a common PCB 350 with the ASIC radar sensor circuit 260. Example component values are shown for C1, C2 being 330 pF and 10 ohms for R1. The basic circuit components for disclosed barrier circuit embodiments are C1, C2, D2, D3 and D4.

While various disclosed embodiments have been described above, it should be understood that they have been presented by way of example only, and not as a limitation. Numerous changes to the disclosed embodiments can be made in accordance with the Disclosure herein without departing from the spirit or scope of this Disclosure. Thus, the breadth and scope of this Disclosure should not be limited by any of the above-described embodiments. Rather, the scope of this Disclosure should be defined in accordance with the following claims and their equivalents.

Although disclosed embodiments have been illustrated and described with respect to one or more implementations, equivalent alterations and modifications will occur to others skilled in the art upon the reading and understanding of this specification and the annexed drawings. While a particular feature may have been disclosed with respect to only one of several implementations, such a feature may be combined with one or more other features of the other implementations as may be desired and advantageous for any given or particular application.

1. An intrinsic safety (IS) barrier circuit comprising:
a circuit board, wherein said IS barrier circuit is formed on said circuit board and includes a signal path that has an input for coupling to an RF output of a radar sensor circuit;
at least one blocking capacitor positioned in said signal path; and
at least one diode coupled between said signal path and a ground,
wherein an output provided by said IS barrier circuit is a protected RF output being limited in energy.

2. The IS barrier circuit of claim 1, wherein said protected RF output comprises a coaxial output.

3. The IS barrier circuit of claim 1, wherein a capacitance of said blocking capacitor is <10 nF.

4. The IS barrier circuit of claim 1, wherein said diode comprises a back-to-back zener diode pair.

5. The IS barrier circuit of claim 1, wherein said diode comprises at least two back-to-back zener diode pairs electrically in parallel to one another.

6. The IS barrier circuit of claim 1, further comprising a gas discharge tube (GDT) and a resistor both electrically in parallel to said diode.

7. A radar system for level sensing a product in a tank, comprising:
a radar level gauge (RLG) including a transceiver providing an RF output coupled to a coaxial connector having its center conductor coupled to a probe at a top of said tank or extending into said tank, wherein said transceiver is coupled to a processor which has an associated memory that includes a stored level finding algorithm, and
an intrinsic safety (IS) barrier circuit coupled between said coaxial connector and said transceiver, wherein said IS barrier circuit comprises:
a circuit board including a signal path that has an input for coupling to said RF output;
at least one blocking capacitor positioned in said signal path,
at least one diode coupled between said signal path and a ground wherein an output provided by said IS barrier circuit is a protected RF coaxial output being limited in energy.

8. The system of claim 7, wherein a capacitance of said blocking capacitor is <10 nF.

9. The system of claim 7 wherein said diode comprises a back-to-back zener diode pair.

10. The system of claim 7, wherein said diode comprises at least two back-to-back zener diode pairs electrically in parallel to one another.

11. The system of claim 7, further comprising a gas discharge tube (GDT) and a resistor both electrically in parallel to said diode.

12. The system of claim 7, wherein said probe extends into said tank, and said radar system comprises a guided wave radar (GWR) system.

13. The system of claim 7, further comprising an explosion proof enclosure, wherein said RLG and said IS barrier circuit are both within said explosion proof enclosure.

14. The system of claim 7, wherein both said RLG and said IS barrier circuit are formed on said circuit board.

15. A method of limiting energy during fault conditions reaching a probe of a radar level gauge (RLG) of a radar system, said RLG providing an RF output to said probe for level sensing a product in a tank including a flammable material, comprising:
providing an intrinsic safety (IS) barrier circuit on a circuit board including a signal path that has an input for coupling to said RF output at least one blocking capacitor in said signal path and at least one clamping diode coupled between in said signal path and a ground,
wherein said IS barrier circuit renders said RF output a protected RF output being limited in energy (limited energy), so that during fault conditions said probe is prevented from igniting said flammable material in said tank due to said limited energy.

16. The method of claim 15, wherein a capacitance of said blocking capacitor is <10 nF.

17. The method of claim 15, wherein said diode comprises a back-to-back zener diode pair.

18. The method of claim 15, wherein said diode comprises at least two back-to-back zener diode pairs electrically in parallel to one another.

19. The method of claim 15, wherein there is a gas discharge tube (GDT) and a resistor both electrically in parallel to said diode.

20. The method of claim 15, wherein said protected RF output comprises a coaxial output.
